(19) United States
(12) Patent Application Publication
(10) Pub. No.: US 2002/0171545 A1
(43) Pub. Date: Nov. 21, 2002

(54) Article care seal

(76) Inventors: Hisashi Endo, Tokyo (JP); Hisao Ohkoshi, Tokyo (JP)

Correspondence Address: Patrick W. Rasche, Armstrong Teasdale LLP, Suite 2600, One Metropolitan Sq., St. Louis, MO, 63102, US

(21) Appl. No.: 10/146,669

(22) Filed: May 14, 2002

(30) Foreign Application Priority Data
May 15, 2001 (JP) 2001-144544

(51) Int. Cl. G08B 1/08

(52) U.S. Cl. 340/539; 340/568.1; 340/572.1; 340/572.8

(57) ABSTRACT

In an article care system intended to perform the search and care of articles efficiently, an article care controller operates in accordance with the command of the controller-holding operator to send a radio signal Q including a transmit request to an article care seal stuck on an article to be searched. The article care seal sends a radio signal R including the care ID code of the self if the radio signal Q from the article care controller is addressed to the self. The article care controller receives the radio signal R from the article care seal, and displays digitally the distance to the article on its distance display section and displays graphically the direction to the article on its direction display section based on the result of reception.

### BACKGROUND OF THE INVENTION

The present invention relates to an article care seal, article care controller and article care system, and more particularly to an article care seal, article care controller and article care system which perform the search and care of articles efficiently.

Conventionally, for stocktaking or referencing of documents, the searching person who looks for an intended article or document (or document file) finds the whereabouts of the article or document by viewing an article keeping book or document keeping book.

Occasionally, care labels, with care ID codes and holding office names being written, are stuck on articles and documents.

However, in case it is difficult to pinpoint the storage place of an article or document, in case an article or document is accessed by a large number of unspecified persons, or in case the quantity of article or document is huge, the care based on the keeping book or keeping label takes considerable labor and time for finding a wanted one.

### SUMMARY OF THE INVENTION

Therefore, it is an object of the present invention to provide an article care seal, article care controller and article care system which perform the search and care of articles efficiently.

At a first viewpoint, the present invention resides in an article care seal, which is characterized by comprising an adhesive surface to be stuck on an article, a care identification (ID) code memory means which stores the care ID code of the self, and a transmit means which sends a radio signal including the care ID code thereby to notify the whereabouts of the article.

The article care seal of the first viewpoint sends a radio signal including the care ID code thereby to notify the whereabouts of the article, and accordingly by sticking the seal on an article to be cared (appliance, tool, material, document, file, etc.), it becomes possible to search for or care an article in need by receiving the radio signal. It enables to save the labor and time for the search and care of articles.

At a second viewpoint, the present invention resides in an article care seal of the above-mentioned arrangement, which is characterized by further including a transmit control means which implements control to send the radio signal periodically.

The article care seal of the second viewpoint sends a radio signal periodically, and accordingly it can reduce the power consumption as compared with the case of continuous transmission.

At a third viewpoint, the present invention resides in an article care seal of the above-mentioned arrangement, which is characterized by further including a reception means which receives a radio signal, and a transmit control means which sends a radio signal including the care ID code of the self if the received radio signal includes a transmit request addressed to the self.

The article care seal of the third viewpoint sends a radio signal including the care ID code of the self if the received radio signal includes a transmit request addressed to the self, and accordingly it can prevent the occurrence of crosstalk based on the radio signal transmission only during the necessary time.

At a fourth viewpoint, the present invention resides in an article care seal, which is characterized by comprising an adhesive surface to be stuck on an article, a care ID code memory means which stores the care ID code of the self, a reception means which receives a radio signal, and a sound output means which emits a sound if the received radio signal includes a sound emission request addressed to the self.

The article care seal of the fourth viewpoint emits a sound if a sound emission request addressed to the self is included in the received radio signal, and accordingly by sticking it on an article, it becomes possible for the searching person to search for the article by being guided by the sound (based on the audition) instead of relying on the vision.

At a fifth viewpoint, the present invention resides in an article care seal, which is characterized by comprising an adhesive surface to be stuck on an article, a care ID code memory means which stores the care ID code of the self, a reception means which receives a radio signal, and a light output means which emits a light if the received radio signal includes a light emission request addressed to the self.

The article care seal of the fifth viewpoint emits a light if a light emission request addressed to the self is included in the received radio signal, and accordingly by sticking it on an article, it becomes possible for the searching person to search for the article by being guided by the light.

At a sixth viewpoint, the present invention resides in an article care seal of the above-mentioned arrangement, which is characterized by being disposable on account of uneasy replacement of the battery.

The article care seal of the sixth viewpoint is designed to be disposable on account of uneasy replacement of the battery, and accordingly it becomes possible to adopt a simple structure of embedding the battery inside the seal and thus reduce the manufacturing cost.

At a seventh viewpoint, the present invention resides in an article care controller, which is characterized by comprising a reception means which receives a radio signal sent from an article care seal of the above-mentioned arrangement, and an article presence/absence indicating means for indication based on the reception result whether the article, with the article care seal being stuck thereon, is present or absent in the vicinity.

The article care controller of the seventh viewpoint enables the searching person to known the presence or absence of the article, with the article care seal being stuck thereon, in one's vicinity.

At an eighth viewpoint, the present invention resides in an article care controller, which is characterized by comprising a reception means which receives a radio signal sent from an article care seal of the above-mentioned arrangement, and a distance indicating means which indicates based on the reception result the distance to the article, with the article care seal being stuck thereon.

The article care controller of the eighth viewpoint enables the searching person to known the distance to the article, with the article care seal being stuck thereon.

At a ninth viewpoint, the present invention resides in an article care controller, which is characterized by comprising a reception means which receives a radio signal sent from an article care seal of the above-mentioned arrangement, and a direction indicating means which indicates based on the reception result the direction to the article, with the article care seal being stuck thereon.

The article care controller of the ninth viewpoint enables the searching person to known the direction to the article, with the article care seal being stuck thereon.

At a tenth viewpoint, the present invention resides in an article care controller, which is characterized by comprising a request transmit means which, in response to a request of searching for an article, sends at least one of a transmit request, a sound emission request and a light emission request to the article care seal which is stuck on the article.

The article care controller of the tenth viewpoint sends a transmit request, a sound emission request or a light emission request to the article care seal at the time when the search is needed, thereby enabling the process needed for the search for the article.

At an eleventh viewpoint, the present invention resides in an article care controller, which is characterized by being a compact terminal unit which is portable by the operator.

The article care controller of the eleventh viewpoint is portable by the operator, and accordingly the operator can use it conveniently while searching for an article.

At a twelfth viewpoint, the present invention resides in an article care controller, which is characterized by comprising a reception means which receives a radio signal sent from an article care seal of the above-mentioned arrangement stuck on an article located in the area of watching of bring-out of the article, and a bring-out indicating means which indicates the bring-out of the article in response to the reception of the radio signal.

The article care controller of the twelfth viewpoint is capable of, for example, giving a warning to the bring-out person in response to the reception of a radio signal from an article located in the area of watching of bring-out of the article, and undoing of bring-out can be expected. Moreover, it can indicate the bring-out to the caretaker who thus can take a proper action.

At a thirteenth viewpoint, the present invention resides in an article care controller, which is characterized by comprising a reception means which receives a radio signal sent from an article care seal of the above-mentioned arrangement stuck on an article located in the area of watching of bring-out of the article, and a bring-out recording means which records the bring-out of the article in response to the reception of the radio signal.

The article care controller of the thirteenth viewpoint records the bring-out of an article in response to the reception of a radio signal from the article located in the area of watching of bring-out of the article, and accordingly it becomes convenient for the later care and action.

At a fourteenth viewpoint, the present invention resides in an article care controller, which is characterized by comprising a reception means which receives a radio signal sent from an article care seal of the above-mentioned arrangement stuck on an article located in the area of watching of bring-in of the article, and a bring-in indicating means which indicates the bring-in of the article in response to the reception of the radio signal.

The article care controller of the fourteenth viewpoint is capable of, for example, giving a warning to the bring-in person in response to the reception of a radio signal from an article located in the area of watching of bring-in of the article, and undoing of bring-in can be expected. Moreover, it can indicate the bring-in to the caretaker, who thus can take a proper action.

At a fifteenth viewpoint, the present invention resides in an article care controller, which is characterized by comprising a reception means which receives a radio signal sent from an article care seal of the above-mentioned arrangement stuck on an article located in the area of watching of bring-in of the article, and a bring-in recording means which records the bring-in of the article in response to the reception of the radio signal.

The article care controller of the fifteenth viewpoint records the bring-in of an article in response to the reception of a radio signal from the article located in the area of watching of bring-in of the article, and accordingly it becomes convenient for the later care and action.

At a sixteenth viewpoint, the present invention resides in an article care system, which is characterized by comprising an article care seal of the above-mentioned arrangement and an article care controller of the above-mentioned arrangement.

The article care system of the sixteenth viewpoint combines an above-mentioned article care seal and an above-mentioned article care controller, and accordingly it enables the proper search and care of articles.

Therefore, the inventive article care seal stuck on an article notifies the whereabouts of the article by emitting a radio signal, light, or sound, whereby it becomes possible to search for articles efficiently. At the same time, it becomes possible to identify the article care seal stuck on each article based on the care ID code, whereby a large number of a variety of articles can be cared individually and efficiently.

The inventive article care controller indicates the presence or absence of a specific article in the vicinity or the distance or direction to the article, whereby it becomes possible to find articles easily. Moreover, the controller warns or records the bring-out or bring-in of articles against rule, whereby it becomes possible to care articles properly.

The inventive article care system combines the inventive article care seal and inventive article care controller, whereby it becomes possible to care articles efficiently.

Further objects and advantages of the present invention will be apparent from the following description of the preferred embodiments of the invention as illustrated in the accompanying drawings.

### BRIEF DESCRIPTION OF DRAWINGS

FIG. 1 is a diagram showing the article care system based on the first embodiment.

FIG. 2 is a functional block diagram showing the article care seal of the article care system of FIG. 1.

FIG. 3 is a cross-sectional diagram showing the article care seal of the article care system of FIG. 1.

FIG. 4 is a functional block diagram showing the article care controller of the article care system of FIG. 1.

FIG. 5 is a flowchart showing the operation of the article care system of FIG. 1.

FIG. 6 is a diagram showing the article care system based on the second embodiment.

FIG. 7 is a functional block diagram showing the article care seal of the article care system of FIG. 6.

FIG. 8 is a functional block diagram showing the article care controller of the article care system of FIG. 6.

FIG. 9 is a flowchart showing the operation of the article care system of FIG. 6.

FIG. 10 is a diagram showing the article care system based on the third embodiment.

FIG. 11 is a functional block diagram showing the article care seal of the article care system of FIG. 10.

FIG. 12 is a functional block diagram showing the article care controller of the article care system of FIG. 10.

FIG. 13 is a flowchart showing the operation of the article care system of FIG. 10.

FIG. 14 is a diagram showing the article care system based on the fourth embodiment.

FIG. 15 is a functional block diagram showing the article care controller of the article care system of FIG. 14.

FIG. 16 is a flowchart showing the operation of the article care system of FIG. 14.

FIG. 17 is a diagram showing the article care system based on the fifth embodiment.

FIG. 18 is a flowchart showing the operation of the article care system of FIG. 17.

### DETAILED DESCRIPTION OF THE INVENTION

The following explains in detail the illustrated embodiments of the present invention. The present invention is not confined to these embodiments however.

First Embodiment

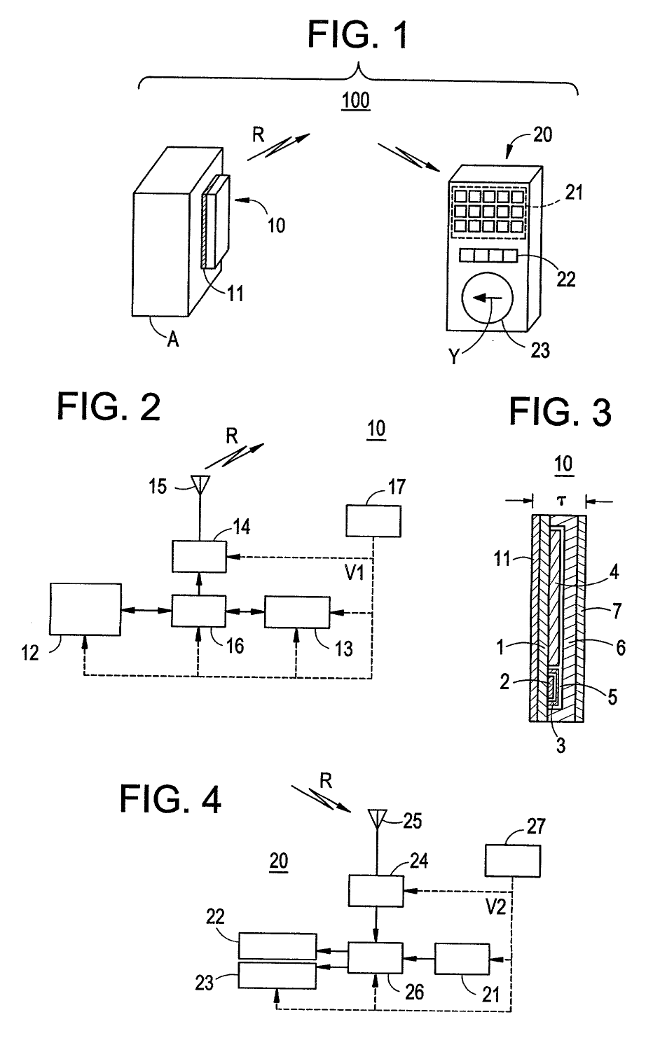

FIG. 1 is a diagram showing the article care system based on the first embodiment of this invention.

This article care system 100 includes an article care seal 10 which sends a radio signal R including the care ID code of the self and an article care controller 20 which has a function of receiving the radio signal R and is portable by being hand-held by the operator (article searching person).

The article care seal 10 has an adhesive surface 11 to be stuck on an article A. The article A can be any of an appliance, tool, material, document and file.

The article care controller 20 has its front face arranged to include an input section 21 which receives commands from the operator, a distance display section 22 which displays digitally the distance to the article A, and a direction display section 23 which displays the direction to the article A graphically in the form of arrow Y.

The system may include a plurality of the article care seal 10 and a plurality of the article care controller 20.

FIG. 2 is a functional block diagram of the article care seal 10.

This article care seal 10 has a care ID code memory section 12 which stores the care ID code of the self, an I/O (input/output) section 13 which enters a care ID code, etc. from an external terminal (not shown), a transmit section 14 and antenna 15 for sending a radio signal R to notify the whereabouts of the article, a control section 16 which implements control to send the radio signal R periodically, and a power supply section 17 which supplies an operation voltage V1 to these sections. The antenna 15 can be a patterned conductor which is shared with the transmit section 14.

The care ID code is a code allotted uniquely to each article care seal 10.

FIG. 3 is a cross-sectional diagram showing the internal structure of the article care seal 10.

The article care seal 10 has a base member 1, an adhesive surface 11 which is formed on the external surface of the base member 1 to have a sticking force at a detachable degree, a battery 2 which functions as the power supply section 17, an insulation spacer 3 which is fitted to cover the battery 2 and accessible from outside to pull-off, an electronic circuit 4 which accomplishes the functions of the sections of FIG. 2, a conductor lug section 5 which comes in contact with the terminal of the battery 2 when the insulation spacer 3 is pulled off, a protection cover 6 which protects the electronic circuit 4 against impacts, and a care label 7 which is stuck on the protection cover 6. A symbol, handling office name, etc. for the identification of the article care seal 10 and article A (e.g., Equipped property: GEYMS, Property number: 123-98765, Handling office: Third engineering section, Equipped date: 1995/10/11) are described on the care label 7.

The article care seal 10 is designed to be disposable by having the embedded battery 2 which does not allow easy replacement, so that the manufacturing cost can be reduced (although the seal must be renewed on expiration of the life time of the battery 2).

The overall thickness τ is about several millimeters, and it is preferably 1 mm or less.

FIG. 4 is a functional block diagram showing the article care controller 20.

This article care controller 20 has an input section 21, a distance display section 22, a direction display section 23, a reception section 24 and antenna 25 for receiving the radio signal R, a control section 26 which implements control to display the distance and direction to the article A (refer to FIG. 1), and a power supply section 27 which supplies an operation voltage V2 to these sections.

The antenna 25 can be a patterned conductor which is shared with the reception section 24.

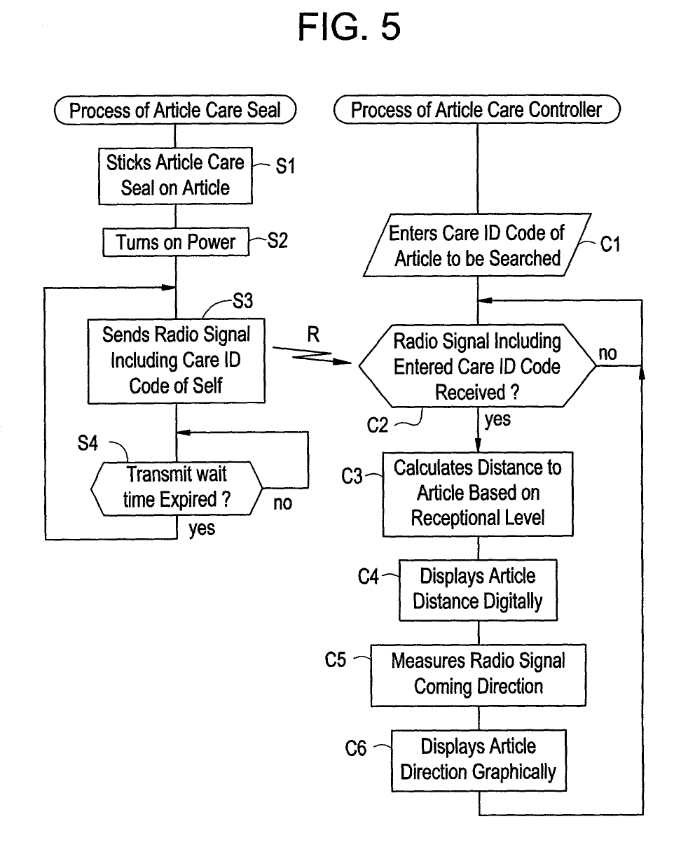

FIG. 5 is a flowchart showing the operation of the article care system 100. The left-hand part is of the article care seal 10, and the right-hand part is of the article care controller 20.

At step S1, the caretaker puts the adhesive surface 11 of the article care seal 10 to the article A thereby to stick on it.

At step S2, the caretaker pulls the insulation spacer 3 off the article care seal 10 thereby to turn on power.

At step S3, the article care seal 10 sends the radio signal R including the care ID code.

At step S4, the sequence returns to the step S3 on expiration of a certain transmit wait time of about several seconds to several tens seconds for example.

At step C1, the operator enters to the article care controller 20 the care ID code of the article care seal 10 stuck on the article A to be searched (this entry is not needed if the article A is specified in advance).

At step C2, the article care controller 20 waits for the reception of the radio signal R which includes the entered care ID code, and proceeds to step C3 upon reception.

At step C3, the article care controller 20 calculates the distance to the article A based on the reception level of the radio signal R.

At step C4, the article care controller 20 displays the distance to the article A on the distance display section 22.

At step C5, the article care controller 20 measures the coming direction of the radio signal R.

At step C6, the article care controller 20 displays the direction to the article A, which is derived from the signal coming direction, on the direction display section 23 (e.g., it displays an arrow with respect to the azimuth of holding of the controller 20 by the operator). After that, the sequence returns to the step C2.

According to the article care system 100 of the foregoing first embodiment, in which the article care seal 10 which sends the radio signal R including the care ID code is stuck on the article A and the article care controller 20 receives the radio signal R and displays the distance and direction to the article A to be searched, it is possible to reduce the labor and time for the search and care of the article A. Moreover, due to the periodical transmission of radio signal, it can reduce the power consumption as compared with the case of continuous transmission.

In the foregoing first embodiment, the article care controller 20 may be designed to indicate, by activation or deactivation of a light emitting diode in response to the reception or no reception of the radio signal R, as to whether or not the article A to be searched is present in the vicinity in place of or in addition to the display of the distance and direction. In this case, it is possible to simplify the arrangement of the article care controller 20 and thus reduce the cost. Otherwise, the article care controller 20 may be designed to release the distance and direction in audible manner in place of or in addition to the display of these information.

Second Embodiment

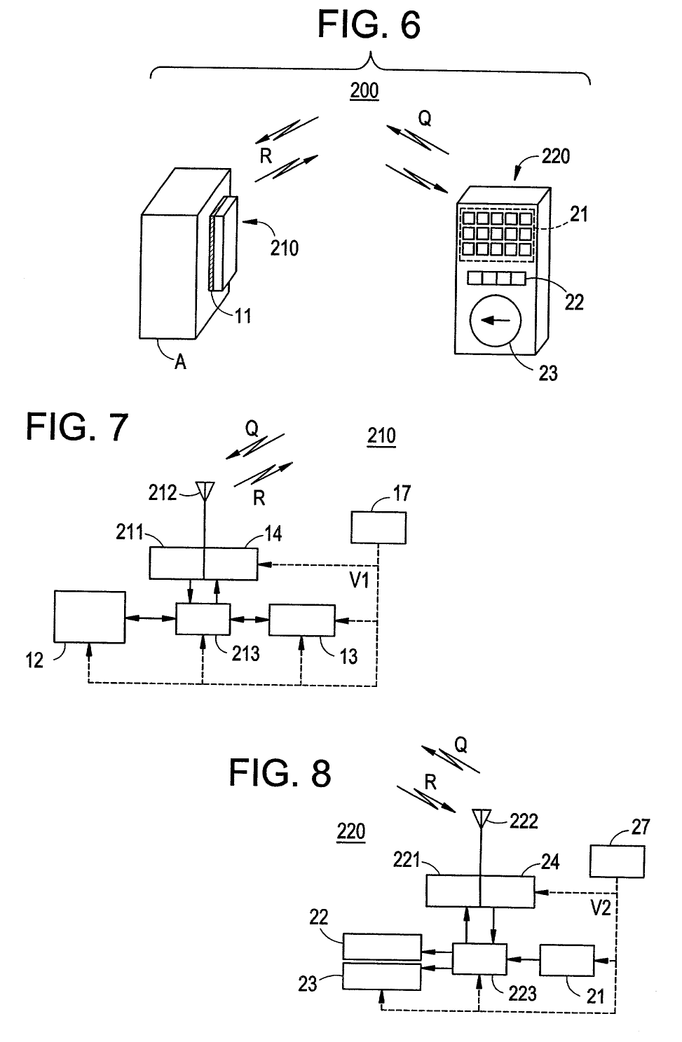

FIG. 6 is a diagram showing the article care system based on the second embodiment of this invention.

This article care system 200 includes an article care seal 210 and an article care controller 220 which is portable by being hand-held by the operator.

The article care seal 210 receives a radio signal Q from the article care controller 220 and sends a radio signal R including the care ID code of the self if the radio signal Q includes a transmit request addressed to the self.

The article care controller 220 responds to the command of the operator to send the radio signal Q including a transmit request to the article care seal 210 stuck on the article A to be searched.

FIG. 7 is a functional block diagram showing the article care seal 210.

This article care seal 210 has a care ID code memory section 12 which stores the care ID code of the self, an I/O section 13 which enters a care ID code, etc. from an external terminal (not shown), a reception section 211 which receives the radio signal Q, a transmit section 14 which sends the radio signal R to notify the whereabouts of the article, an antenna 212 for transmission and reception, a control section 213 which implements control to send the radio signal R if the radio signal Q includes a transmit request addressed to the self, and a power supply section 17 which supplies an operation voltage V1 to these sections.

FIG. 8 is a functional block diagram showing the article care controller 220.

This article care controller 220 has an input section 21, a distance display section 22, a direction display section 23, a transmit section 221 which sends the radio signal Q, a reception section 24 which receives the radio signal R, an antenna 222 for transmission and reception, a control section 223 which implements control to display the distance and direction to the article A (refer to FIG. 6), and a power supply section 27 which supplies an operation voltage V2 to these sections.

The antenna 222 can be a patterned conductor which is shared with the transmit section 221 or reception section 24.

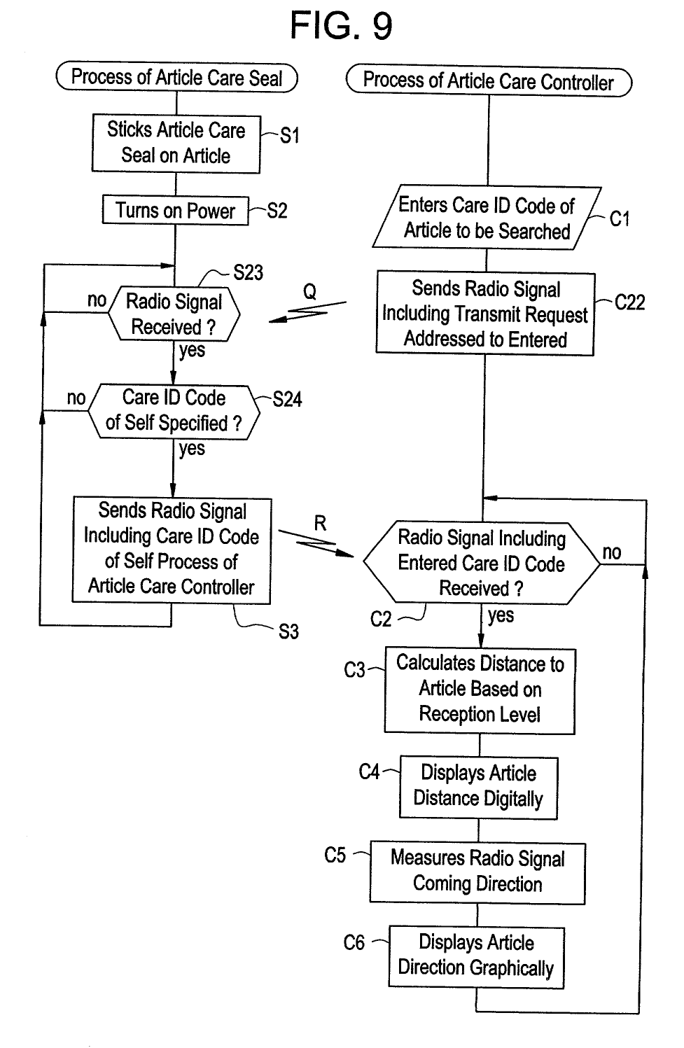

FIG. 9 is a flowchart showing the operation of the article care system 200. The left-hand part is of the article care seal 210, and the right-hand part is of the article care controller 220.

At step S1, the caretaker sticks the article care seal 210 on the article A.

At step S2, the caretaker turns on power of the article care seal 210.

At step C1, the operator enters the care ID code of the article A to be searched to the article care controller 220.

At step C22, the article care controller 220 sends the radio signal Q including a transmit request destined to the entered care ID code.

At step S23, the article care seal 210 waits for the reception of the radio signal Q, and proceeds to step S24 upon reception.

At step S24, the article care seal 210 proceeds to step S3 if the radio signal Q is destined to the care ID code of the self, or otherwise returns to step S23.

At step C2, the article care controller 220 waits for the reception of the radio signal R which includes the entered care ID code, and proceeds to step C3 upon reception.

At step C3, the article care controller 220 calculates the distance to the article A based on the reception level of the radio signal R.

At step C4, the article care controller 220 displays the distance to the article A on the distance display section 22.

At step C5, the article care controller 220 measures the coming direction of the radio signal R.

At step C6, the article care controller 220 displays the direction to the article A, which is derived from the signal coming direction, on the direction display section 23. After that, the sequence returns to the step C2.

According to the article care system 200 of the foregoing second embodiment, in which the article care seal 210 sends the radio signal R in response to the transmit request from the article care controller 220, it is possible to prevent the crosstalk caused by the transmission of article care seals other than that to be searched.

Third Embodiment

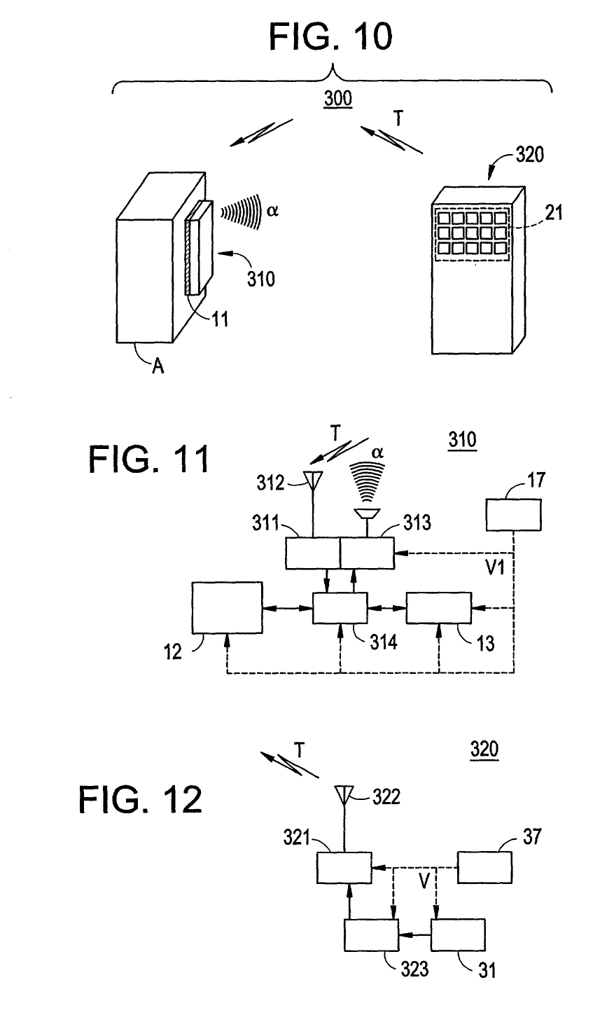

FIG. 10 is a diagram showing the article care system based on the third embodiment of this invention.

This article care system 300 includes an article care seal 310 and an article care controller 320 which is equipped with an input section 21 for receiving commands from the operator.

The article care seal 310 receives a radio signal T from the article care controller 320, and emits an electronic sound α if the radio signal T includes a sound emission request addressed to the self.

The article care controller 320 responds to the command of the operator to send the radio signal T including a sound emission request to the article care seal 310 which is stuck on the article A to be searched.

FIG. 11 is a functional block diagram showing the article care seal 310.

This article care seal 310 has a care ID code memory section 12 which stores the care ID code of the self, an I/O section 13 which enters a care ID code, etc. from an external terminal (not shown), a reception section 311 and antenna 312 for receiving the radio signal T, a sound output section 313 which emits an electronic sound α (buzzing or peeping sound), a control section 314 which implements control to emit the electronic sound α if the radio signal T includes a sound emission request addressed to the self, and a power supply section 17 which supplies an operation voltage V1 to these sections.

FIG. 12 is a functional block diagram showing the article care controller 320.

This article care controller 320 has an input section 31, a transmit section 321 and antenna 322 for sending the radio signal T, a control section 323 which implements control to transmit the radio signal T, and a power supply section 37 which supplies an operation voltage V2 to these sections.

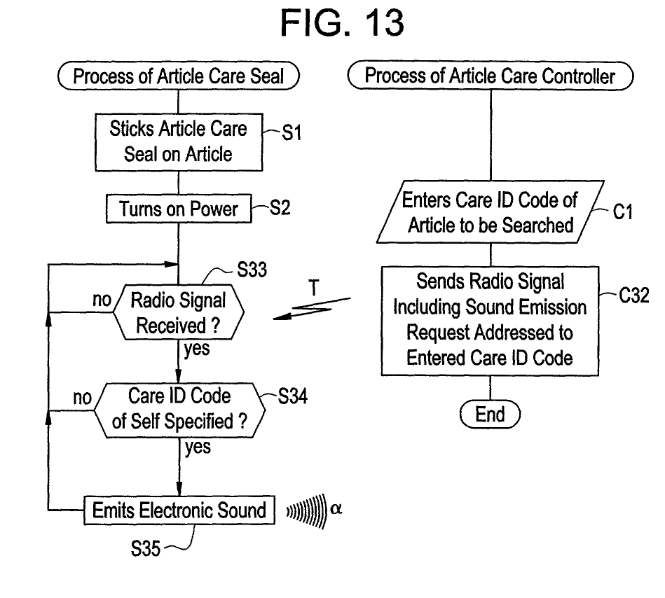

FIG. 13 is a flowchart showing the operation of the article care system 300. The left-hand part is of the article care seal 310, and the right-hand part is of the article care controller 320.

At step S1, the caretaker sticks the article care seal 310 on the article A.

At step S2, the caretaker turns on power of the article care seal 310.

At step C1, the operator enters the care ID code of the article A to be searched to the article care controller 320.

At step C32, the article care controller 320 sends the radio signal T including a sound emission request destined to the entered care ID code.

At step S33, the article care seal 310 waits for the reception of the radio signal T, and proceeds to step S34 upon reception.

At step S34, the article care seal 310 proceeds to step S35 if the radio signal T is destined to the care ID code of the self, or otherwise returns to step S33.

At step 35, the article care seal 310 emits an electronic sound α for a certain duration, e.g., several seconds to several tens seconds. After that, the sequence returns to the step S33.

According to the article care system 300 of the foregoing third embodiment, it is possible to search for an article A by being guided by the electronic sound α emitted by the article care seal 310 instead of relying on the vision (consequently, it enables sight-disabled persons to search for articles). Moreover, the article care controller 320 does not need to equip a distance display section 22 and direction display section 23 (refer to FIG. 1 and FIG. 6), and therefore the cost can be reduced.

In the foregoing third embodiment, the article care seal 310 may be designed to emit a light in place of or in addition to the emission of electronic sound.

Fourth Embodiment

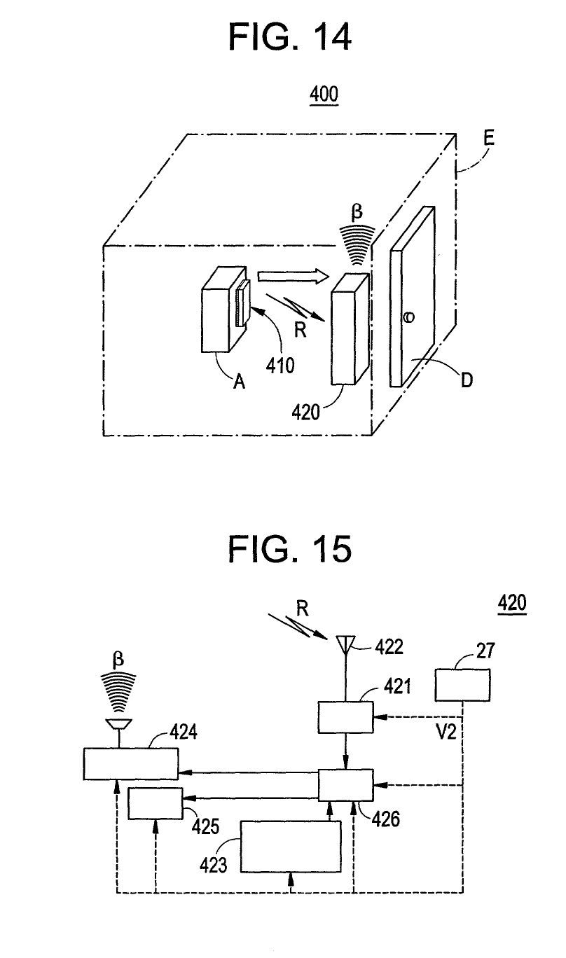

FIG. 14 is a diagram showing the article care system based on the fourth embodiment of this invention.

This article care system 400 includes an article care seal 410 stuck on an article A which is restricted in terms of bring-out of a certain bring-out restriction area E (the restriction includes in one case the concept of prohibition) and an article care controller 420 which is installed in the vicinity of a door D used to bring articles in and out of the bring-out restriction area E and adapted to emit a warning sound β in response to the reception of a radio signal R from the article care seal 410 at a certain reception level or higher.

The article care seal 410 has the same arrangement as the article care seal 10 of the foregoing first embodiment (refer to FIG. 1 through FIG. 3).

FIG. 15 is a functional block diagram showing the article care controller 420.

This article care controller 420 has a reception section 421 and antenna 422 for receiving the radio signal R, a bring-out restricted care ID code memory section 423 which stores the care ID code of the article care seal 410 stuck on the bring-out restricted article A, a warning sound output section 424 which emits a warning sound β, a recording section 425 which records the bring-out of the article A, a control section 426 which implements control to emit the warning sound β and record the bring-out, and a power supply section 27 which supplies an operation voltage V2 to these sections.

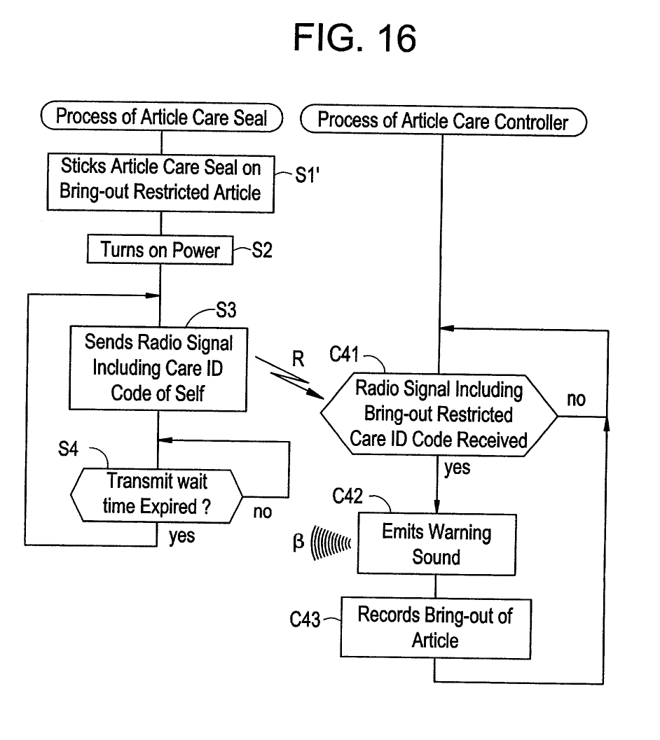

FIG. 16 is a flowchart showing the operation of the article care system 400. The left-hand part is of the article care seal 410, and the right-hand part is of the article care controller 420.

At step S1′, the caretaker sticks the article care seal 410 on the article A, with the bring-out restriction being imposed thereon.

At step S2, the caretaker turns on power of the article care seal 410.

At step S3, the article care seal 410 sends the radio signal R including the care ID code.

At step S4, the sequence returns to the step S3 on expiration of a certain transmit wait time.

At step C41, the article care controller 420 waits for the reception of the radio signal R including the bring-out restricted care ID code, and proceeds to step C42 upon reception.

At step C42, the article care controller 420 emits the warning sound β. This sound gives a warning to the person who is about to bring out the bring-out restricted article A carelessly or against rule, and undoing of bring-out can be expected.

At step C43, the article care controller 420 records the bring-out of the bring-out restricted article A (bring-out is done in one case or aborted in another case). After that, the sequence returns to the step C41.

According to the article care system 400 of the foregoing fourth embodiment, in which the article care controller 420 emits a warning sound β at the bring-out of a bring-out restricted article A, it is possible to give a warning to the bring-out person. Recording the bring-out facilitates the later care and action.

In the foregoing fourth embodiment, the article care controller 420 may be designed to indicate the bring-out of a bring-out restricted article A to a central watching room, etc. via a network such as LAN (Local Area Network) at the time of bring-out in place of or in addition to the emission of warning sound β and the recording. The door D may be forced to lock in its closed state so as to prevent the bring-out in physical fashion.

Fifth Embodiment

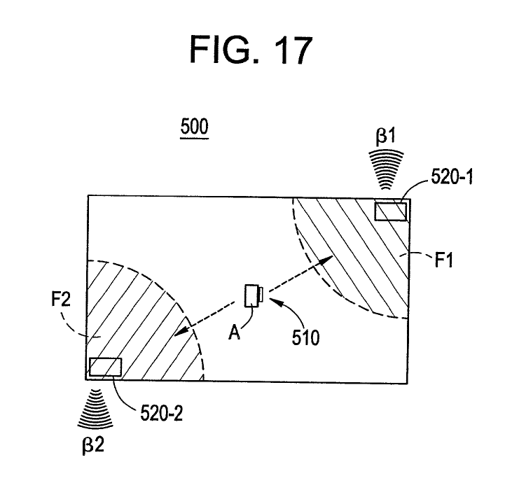

FIG. 17 is a diagram showing the article care system based on the fifth embodiment of this invention.

This article care system 500 includes an article care seal 510 stuck on an article A which is restricted in terms of bring-in to one of a first separating area F1 and a second separating area F2, an article care controller 520-1 which is installed in the first separating area F1 and an article care controller 520-2 which is installed in the second separating area F2. The article care seal 510 has the same arrangement as the article care seal 10 of the foregoing first embodiment (refer to FIG. 1 through FIG. 3).

The article care controller 520-1 has a record of the care ID codes of the article care seals 510 stuck on the articles which are to be brought into the first separating area F1, and it emits a warning sound β1 upon receiving at a certain reception level or higher a radio signal R which includes a care ID code other than those recorded.

The article care controller 520-2 has a record of the care ID codes of the article care seals 510 stuck on the articles which are to be brought into the second separating area F2, and it emits a warning sound β2 upon receiving at a certain reception level or higher a radio signal R which includes a care ID code other than those recorded.

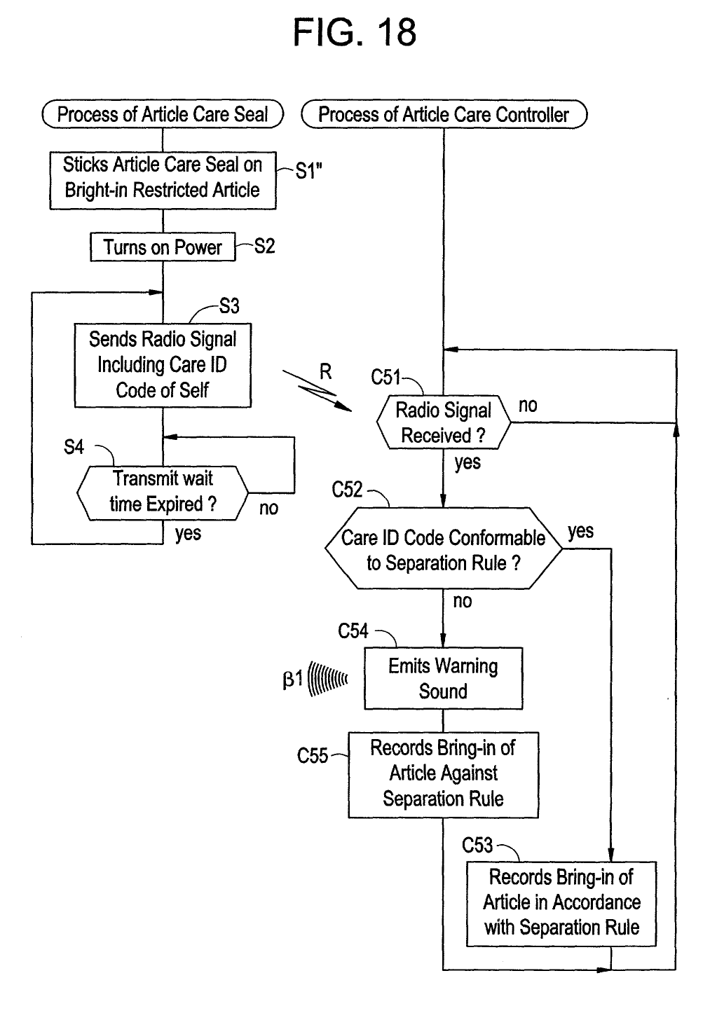

FIG. 18 is a flowchart showing the operation of the article care system 500. The left-hand part is of the article care seal 510, and the right-hand part is of the article care controller 520-1 (520-2 has the same operation).

At step S1″, the caretaker sticks the article care seal 510 on the article A, with the bring-in restriction in one of the first separating area F1 and second separating area F2 being imposed thereon.

At step S2, the caretaker turns on power of the article care seal 510.

At step S3, the article care seal 510 sends the radio signal R including the care ID code.

At step S4, the sequence returns to the step S3 on expiration of a certain transmit wait time.

At step C51, the article care controller 520-1 waits for the reception of the radio signal R at the reception level or higher, and proceeds to step C52 upon reception.

At step C52, the article care controller 520-1 judges as to whether or not the care ID code included in the radio signal R is conformable to the rule of separation (whether it is a care ID code of an article care seal 510 stuck on an article A which is to be brought into the first separating area F1), and the sequence proceeds to step C53 if it is conformable, or otherwise proceeds to step C54.

At step C53, the article care controller 520-1 records the bring-in which is comfortable to the separation rule. After that, the sequence returns to the step C51.

At step C54, the article care controller 520-1 emits the warning sound β1. This sound gives a warning to the person who is about to bring in the bring-in restricted article A carelessly or against rule, and undoing of bring-in can be expected.

At step C55, the article care controller 520-1 records the bring-in which is against the separation rule. After that, the sequence returns to the step C51.

According to the article care system 500 of the foregoing fifth embodiment, in which the article care controller 520-1 or 520-2 emits a warning sound β1 or β2 if a restricted article A (harmful object, substance, etc.) having its storage or discarding place restricted to be one of the first separating area F1 and second separating area F2 is brought into an improper area, it is possible to give a warning to the bring-in person. Recording the bring-in facilitates the later care and action.

In the foregoing fifth embodiment, the number of separating areas may be three or more. If it is intended to restrict simply the bring-in for the prevention of erroneous discarding of articles for example, only one area may be the case.

Many widely different embodiments of the invention may be configured without departing from the spirit and the scope of the present invention. It should be understood that the present invention is not limited to the specific embodiments described in the specification, except as defined in the appended claims.

1. An article care seal comprising:
an adhesive surface to be stuck on an article;
a care identification (ID) code memory device which stores the care ID code of the self; and
a transmit device which sends a radio signal including the care ID code thereby to notify the whereabouts of the article.

2. The article care seal according to claim 1 further comprising a transmit control device which implements control to send the radio signal periodically.

3. The article care seal according to claim 1 further comprising:
a reception device which receives a radio signal; and
a transmit control device which sends a radio signal including the care ID code of the self if the received radio signal includes a transmit request addressed to the self.

4. An article care seal comprising:
an adhesive surface to be stuck on an article;
a care ID code memory device which stores the care ID code of the self;
a reception device which receives a radio signal; and
a sound output device which emits a sound if the received radio signal includes a sound emission request addressed to the self.

5. An article care seal comprising:
an adhesive surface to be stuck on an article;
a care ID code memory device which stores the care ID code of the self;
a reception device which receives a radio signal; and
a light output device which emits a light if the received radio signal includes a light emission request addressed to the self.

6. The article care seal according to any of claim 1, claim 4 and claim 5 characterized by being disposable on account of uneasy replacement of the battery.
